(19) United States
(12) Patent Application Publication
(10) Pub. No.: US 2007/0007680 A1
(43) Pub. Date: Jan. 11, 2007

(54) Methods for controlling polyethylene rheology

(75) Inventors: Vincent Henri Barre, Jacksonville, FL (US); Son Nguyen, Friendswood, TX (US); Cyril Chevillard, Dickinson, TX (US); Gerhard Guenther, Seabrook, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/174,815

(22) Filed: Jul. 5, 2005

(51) Int. Cl. B29C 45/76

(52) U.S. Cl. 264/40.1

(57) ABSTRACT

The rheology of polyethylene resin may be controlled by measuring the specific energy input (SEI) to the extruder and then adjusting a process parameter in response to a change in the SEI and/or by introducing both a free radical initiator and an alkali earth metal stearate into the polymerization. Indeed, the process parameter changed in response to the SEI measurement may be adjusting the proportion of free radical initiator, adjusting the proportion of alkali earth metal stearate, or both. The free radical initiator may be a peroxide, and the alkali earth metal stearate may be calcium stearate.

### FIELD OF THE INVENTION

The invention is related to methods and compositions useful to improve the manufacture of sheets or blown films and other structures from polyethylene resin. It relates more particularly to methods for improving the rheology of polyethylene resins, and copolymers thereof.

### BACKGROUND OF THE INVENTION

Among the different possible ways to convert polymers into films, the blown film process with air-cooling is probably the most economical and also the most widely used. This is because films obtained by blowing have a tubular shape which makes them particularly advantageous in the production of bags for a wide variety of uses (e.g. bags for urban refuse, bags used in the storage of industrial materials, for frozen foods, carrier bags, etc.) as the tubular structure enables the number of welding joints required for formation of the bag to be reduced when compared with the use of flat films, with consequent simplification of the process. Moreover, the versatility of the blown-film technique makes it possible, simply by varying the air-insufflation parameters, to obtain tubular films of various sizes, therefore avoiding having to trim the films down to the appropriate size as is necessary in the technique of extrusion through a flat head.

Currently over 21 billion pounds of plastics are used in the U.S. each year for packaging. High density polyethylene (HDPE) blown films represent a substantial portion of this total. The blown film process is a diverse conversion system used for polyethylene. ASTM defines films as being of less than 0.254 mm (10 mils) in thickness; however, the blown film process may produce materials as thick as 0.5 mm (20 mils). It is important to produce HDPE films having high melt strength, good mechanical properties, and ease of processing that enable blown extrusion in structures with good bubble stability.

In order to increase the blown film bubble stability of bimodal polyethylene film material, the addition of peroxides in the extrusion system induces long chain branching (LCB) and improves the processing performance. Other free radical initiators such as oxygen may be used. The amount of LCB and chain scission of a polyethylene resin is affected by extrusion conditions. Due to these reactive properties, a similar fluff can exhibit different rheological behaviors with varying extrusion conditions. In particular, materials that are altered via radical degradation can undergo very significant changes in rheology. It is necessary and desirable to control these changes to produce a more consistent, predictable resin and ultimate product.

Several applications for HDPE include, but are not limited to, industrial bags, bags for frozen foods, carrier bags, heavy-duty shipping sacks, mailing envelopes, shrink films, among others. There is a constant need for materials having improved properties for particular applications.

It would be desirable if methods could be devised or discovered to provide polyethylene film or sheet materials having improved properties, particularly more consistent and/or predictable rheology.

### SUMMARY OF THE INVENTION

There is provided, in one form, a method for controlling the rheology of polyethylene that involves polymerizing ethylene monomer as a polymerization mixture and extruding the polyethylene resin with an extruder. The rheology of the polyethylene resin is controlled by a process such as measuring the specific energy input (SEI) to the extruder and adjusting a process parameter in response to a change in SEI, but may also be controlled by introducing a free radical initiator and a neutralizing species into the polymerization mixture. The neutralizing species include, but are not necessarily limited to, alkali metal stearates, alkali earth metal stearates, metal stearates and metal oxides.

In another embodiment, there is provided a polyethylene resin having a controlled rheology that is made by a method concerning polymerizing ethylene monomer as a polymerization mixture, and extruding the polyethylene resin with an extruder. The rheology of polyethylene resin is controlled by a process that involves measuring the SEI to the extruder and adjusting a process parameter in response to a change in SEI, and/or may involve introducing a free radical initiator and a neutralizing species into the polymerization mixture. The neutralizing species may be any of those noted above and combinations thereof.

In other non-restrictive embodiments, there are also provided a method of blowing a film of the polyethylene resins described, and articles of manufacture comprising these reins including, but not necessarily limited to, films, fibers, blow molded articles and injection molded articles.

### BRIEF DESCRIPTION OF THE DRAWINGS

FIG. 1 is a schematic plot of the curve of viscosity of polyethylene resin with shear rate at various levels of long chain branching;

FIG. 2 shows a plot of extruder rotor SEI as a function of throughput for a January run at two different peroxide levels and the transition between them;

FIG. 3 shows a plot of extruder rotor SEI as a function of throughput for a February run at two different peroxide levels;

FIG. 4 shows a plot of extruder rotor SEI as a function of throughput for a March run at two different peroxide levels;

FIG. 5 shows a plot of extruder rotor SEI as a function of throughput for an April run at two different peroxide levels;

FIG. 6 shows a plot of extruder rotor SEI as a function of throughput for a May run at two different peroxide levels;

FIG. 7 is a plot of rotor SEI as a function of throughput for several high molecular weight bimodal HDPE runs of similar rheology (similar rheological breadth parameters, as indicated);

FIG. 8 is a graph of the GP SEI as a function of throughput for a June high molecular weight bimodal HDPE run;

FIG. 9 is a graph of the GP SEI/screen pack pressure as a function of throughput for a June high molecular weight bimodal HDPE run;

FIG. 10 is a plot of GP SEI/pressure as a function of throughput during a February high molecular weight bimodal HDPE run at two different target peroxide levels;

FIG. 11 is a plot of GP SEI/pressure as a function of throughput during a March high molecular weight bimodal HDPE run at two different target peroxide levels;

FIG. 12 is a plot of GP SEI/pressure as a function of throughput during a April high molecular weight bimodal HDPE run at two different target peroxide levels;

FIG. 13 is a plot of GP SEI/pressure as a function of throughput during a May high molecular weight bimodal HDPE run at two different target peroxide levels;

FIG. 14 is a plot of GP SEI/pressure as a function of throughput for materials of different rheological breadth parameters;

FIG. 15 is a plot of percent error of the breadth parameter as a function of peroxide level for various HDPEs, with zinc oxide, calcium stearate (CaSt) or neither component;

FIG. 16 is a bar graph showing the average breadth parameter for high molecular weight bimodal HDPE runs performed using 11 ppm of peroxide and CaSt as a neutralizing agent; and

FIG. 17 is a bar graph showing the average breadth parameter for high molecular weight bimodal HDPE runs performed using zinc oxide as a neutralizing agent.

### DETAILED DESCRIPTION OF THE INVENTION

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology. Various terms as used herein are shown below. To the extent a term used in a claim is not defined below, it should be given the broadest definition persons in the pertinent art have given that term as reflected in printed publications and issued patents.

Certain polymerization processes disclosed herein involve contacting polyolefin monomers with one or more catalyst systems to form a polymer. Such polymers may be used to form polymer articles.

Catalyst Systems

The catalyst systems used herein may be characterized as supported catalyst systems or as unsupported catalyst systems, sometimes referred to as homogeneous catalysts. The catalyst systems may be metallocene catalyst systems, Ziegler-Natta catalyst systems or other catalyst systems known to one skilled in the art for the production of polyolefins, for example. A brief discussion of such catalyst systems is included below, but is in no way intended to limit the scope of the invention to such catalysts.

A. Ziegler-Natta Catalyst System

Ziegler-Natta catalyst systems are generally formed from the combination of a metal component (e.g., a catalyst precursor) with one or more additional components, such as a catalyst support and/or a cocatalyst. One or more electron donors may optionally be present.

A specific example of a catalyst precursor is a metal component generally represented by the formula:
MRₓ;
where M is a transition metal, R is a halogen, an alkoxy, or a hydrocarboxyl group and x is the valence of the transition metal. For example, x may be from 1 to 4. The transition metal of the Ziegler-Natta catalyst compound, as described throughout the specification and claims, may be selected from Groups IV through VIB in one embodiment and selected from titanium, chromium, or vanadium in a more particular embodiment. R may be selected from chlorine, bromine, carbonate, ester, or an alkoxy group in one embodiment. Examples of catalyst precursors include, but are not necessarily limited to, TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃.

Those skilled in the art will recognize that a catalyst is “activated” in some way before it is useful for promoting polymerization. As discussed further below, activation may be accomplished by combining the catalyst with an activator, which is also referred to in some instances as a “cocatalyst.” As used herein, the term “Z-N activator” refers to any compound or combination of compounds, supported or unsupported, which may activate a Z-N catalyst precursor. Embodiments of such activators include, but are not necessarily limited to, organoaluminum compounds, such as trimethyl aluminum (TMA), triethyl aluminum (TEAl) and triisobutyl aluminum (TiBAl), for example. The Ziegler-Natta catalyst system may further optionally include one or more electron donors, such as internal electron donors and/or external electron donors. Internal electron donors may be used to reduce the atactic form of the resulting polymer, thus decreasing the amount of xylene solubles in the polymer.

The components of the Ziegler-Natta catalyst system (e.g., catalyst precursor, activator and/or optional electron donors) may or may not be associated with a support, either in combination with each other or separate from one another. Typical support materials may include a magnesium dihalide, such as magnesium dichloride or magnesium dibromide, for example.

Ziegler-Natta catalyst systems and processes for forming such catalyst systems are described in at least U.S. Pat. Nos. 4,298,718; 4,544,717 and 4,767,735, which are incorporated by reference herein.

B. Metallocene Catalyst System

Metallocene catalysts may be characterized generally as coordination compounds incorporating one or more cyclopentadienyl (Cp) groups (which may be substituted or unsubstituted, each substitution being the same or different) coordinated with a transition metal through π bonding.

The Cp substituent groups may be linear, branched or cyclic hydrocarbyl radicals. The cyclic hydrocarbyl radicals may further form other contiguous ring structures, including, for example indenyl, azulenyl and fluorenyl groups. These additional ring structures may also be substituted or unsubstituted by hydrocarbyl radicals, such as C₁ to C₂₀ hydrocarbyl radicals.

A specific example of a metallocene catalyst is a bulky ligand metallocene compound generally represented by the formula:
[L]ₘM[A]ₙ;
where L is a bulky ligand, A is a leaving group, M is a transition metal and m and n are such that the total ligand valency corresponds to the transition metal valency. For example m may be from 1 to 3 and n may be from 1 to 3.

The metal atom “M” of the metallocene catalyst compound, as described throughout the specification and claims, may be selected from Groups 3 through 12 atoms and lanthanide Group atoms in one embodiment, selected from Groups 3 through 10 atoms in a more particular embodiment, selected from Sc, Ti, Zr, Hf, V, Nb, Ta, Mn, Re, Fe, Ru, Os, Co, Rh, Ir, and Ni in yet a more particular embodiment, selected from Groups 4, 5 and 6 atoms in yet a more particular embodiment, Ti, Zr, Hf atoms in yet a more particular embodiment and Zr in yet a more particular alternate embodiment. The oxidation state of the metal atom “M” may range from 0 to +7 in one embodiment, in a more particular embodiment, is +1, +2, +3, +4 or +5 and in yet a more particular embodiment is +2, +3 or +4. The groups bounding the metal atom “M” are such that the compounds described below in the formulas and structures are electrically neutral, unless otherwise indicated.

The bulky ligand generally includes a cyclopentadienyl group (Cp) or a derivative thereof. The Cp ligand(s) form at least one chemical bond with the metal atom M to form the “metallocene catalyst compound”. The Cp ligands are distinct from the leaving groups bound to the catalyst compound in that they are not highly susceptible to substitution/abstraction reactions.

Cp typically includes fused ring(s) or ring systems. The ring(s) or ring system(s) typically include atoms selected from group 13 to 16 atoms, for example, carbon, nitrogen, oxygen, silicon, sulfur, phosphorous, germanium, boron, aluminum and combinations thereof, wherein carbon makes up at least 50% of the ring members. Non-limiting examples include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or H₄Ind), substituted versions thereof and heterocyclic versions thereof.

Cp substituent groups may include hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbomoyls, alkyl- and dialkyl-carbamoyls, acyloxys, acylaminos, aroylaminos and combinations thereof. More particular non-limiting examples of alkyl substituents include methyl, ethyl, propyl, butyl, pentyl, hexyl, cyclopentyl, cyclohexyl, benzyl, phenyl, methylphenyl, and tert-butylphenyl groups and the like, including all their isomers, for example tertiary-butyl, isopropyl and the like. Other possible radicals include substituted alkyls and aryls such as, for example, fluoromethyl, fluoroethyl, difluoroethyl, iodopropyl, bromohexyl, chlorobenzyl and hydrocarbyl substituted organometalloid radicals including trimethylsilyl, trimethylgermyl, methyldiethylsilyl and the like, halocarbyl-substituted organometalloid radicals including tris(trifluoromethyl)silyl, methylbis(difluoromethyl)silyl, bromomethyidimethylgermyl and the like, disubstituted boron radicals including dimethylboron for example, disubstituted Group 15 radicals including dimethylamine, dimethylphosphine, diphenylamine, methylphenylphosphine and Group 16 radicals including methoxy, ethoxy, propoxy, phenoxy, methylsulfide and ethylsulfide. Other substituents R include olefins, such as but not limited to, olefinically unsaturated substituents including vinyl-terminated ligands, for example 3-butenyl, 2-propenyl, 5-hexenyl and the like. In one embodiment, at least two R groups, two adjacent R groups in one embodiment, are joined to form a ring structure having from 3 to 30 atoms selected from carbon, nitrogen, oxygen, phosphorous, silicon, germanium, aluminum, boron and combinations thereof. Also, a substituent group R group such as 1-butanyl, may form a bonding association to the element M.

Each anionic leaving group is independently selected and may include any leaving group, such as halogen ions, hydrides, C₁ to C₁₂ alkyls, C₂ to C₁₂ alkenyls, C₆ to C₁₂ aryls, C₇ to C₂₀ alkylaryls, C₁ to C₁₂ alkoxys, C₆ to C₁₆ aryloxys, C₇ to C₁₈ alkylaryloxys, C₁ to C₁₂ fluoroalkyls, C₆ to C₁₂ fluoroaryls, C₁ to C₁₂ heteroatom-containing hydrocarbons and substituted derivatives thereof, hydride, halogen ions, C₁ to C₆ alkylcarboxylates, C₁ to C₆ fluorinated alkylcarboxylates, C₆ to C₁₂ arylcarboxylates, C₇ to C₁₈ alkylarylcarboxylates, C₁ to C₆ fluoroalkyls, C₂ to C₆ fluoroalkenyls and C₇ to C₁₈ fluoroalkylaryls in yet a more particular embodiment, hydride, chloride, fluoride, methyl, phenyl, phenoxy, benzoxy, tosyl, fluoromethyls and fluorophenyls in yet a more particular embodiment, C₁ to C₁₂ alkyls, C₂ to C₁₂ alkenyls, C₆ to C₁₂ aryls, C₇ to C₂₀ alkylaryls, substituted C₁ to C₁₂ alkyls, substituted C₆ to C₁₂ aryls, substituted C₇ to C₂₀ alkylaryls, C₁ to C₁₂ heteroatom-containing alkyls, C₁ to C₁₂ heteroatom-containing aryls and C₁ to C₁₂ heteroatom-containing alkylaryls in yet a more particular embodiment, chloride, fluoride, C₁ to C₆ alkyls, C₂ to C₆ alkenyls, C₇ to C₁₈ alkylaryls, halogenated C₁ to C₆ alkyls, halogenated C₂ to C₆ alkenyls and halogenated C₇ to C₁₈ alkylaryls in yet a more particular embodiment, fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls) in yet a more particular embodiment and fluoride in yet a more particular embodiment.

Other non-limiting examples of leaving groups include, but are not necessarily limited to, amines, phosphines, ethers, carboxylates, dienes, hydrocarbon radicals having from 1 to 20 carbon atoms, fluorinated hydrocarbon radicals (e.g., —C₆F₅ (pentafluorophenyl)), fluorinated alkylcarboxylates (e.g., CF₃C(O)O⁻), hydrides, halogen ions and combinations thereof. Other examples of leaving groups include, but are not necessarily limited to, alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, dimethylphosphide radicals and the like. In one non-limiting embodiment, two or more leaving groups form a part of a fused ring or ring system.

L and A may be bridged to one another. A bridged metallocene, for example may, be described by the general formula:
XCp^{A}Cp^{B}MAₙ;
wherein X is a structural bridge, Cp^{A} and Cp^{B} each denote a cyclopentadienyl group, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups (X) include divalent hydrocarbon groups containing at least one Group 13 to 16 atom, such as but not limited to, at least one of a carbon, oxygen, nitrogen, silicon, aluminum, boron, germanium, tin and combinations thereof; wherein the heteroatom may also be C₁ to C₁₂ alkyl or aryl substituted to satisfy neutral valency. The bridging group may also contain substituent groups as defined above including halogen radicals and iron. More particular non-limiting examples of bridging groups are represented by C₁ to C₆ alkylenes, substituted C₁ to C₆ alkylenes, oxygen, sulfur, R₂C═, R₂Si═, —Si(R)₂Si(R₂)— and R₂Ge═, RP═ (wherein “═” represents two chemical bonds), where R is independently selected from the group hydride, hydrocarbyl, substituted hydrocarbyl, halocarbyl, substituted halocarbyl, hydrocarbyl-substituted organometalloid, halocarbyl-substituted organometalloid, disubstituted boron, disubstituted Group 15 atoms, substituted Group 16 atoms and halogen radicals and wherein two or more Rs may be joined to form a ring or ring system. In one embodiment, the bridged metallocene catalyst component has two or more bridging groups (X).

As used herein, the term “metallocene activator” is defined to be any compound or combination of compounds, supported or unsupported, which may activate a single-site catalyst compound (e.g., metallocenes, Group 15 containing catalysts, etc.) Typically, this involves the abstraction of at least one leaving group (A group in the formulas/structures above, for example) from the metal center of the catalyst component. The catalyst components herein are thus activated towards olefin polymerization using such activators. Embodiments of such activators include Lewis acids such as cyclic or oligomeric polyhydrocarbylaluminum oxides and so called non-coordinating ionic activators (“NCA”), alternately, “ionizing activators” or “stoichiometric activators”, or any other compound that may convert a neutral metallocene catalyst component to a metallocene cation that is active with respect to olefin polymerization.

More particularly, it is within the scope herein to use Lewis acids such as alumoxane (e.g., “MAO”), modified alumoxane (e.g., “TIBAO”) and alkylaluminum compounds as activators, to activate desirable metallocenes described herein. MAO and other aluminum-based activators are well known in the art. Non-limiting examples of aluminum alkyl compounds which may be utilized as activators for the catalysts described herein include trimethylaluminum, triethylaluminum, triisobutylaluminum, tri-n-hexylaluminum, tri-n-octylaluminum and the like.

Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). Examples of neutral ionizing activators include Group 13 tri-substituted compounds, in particular, tri-substituted boron, tellurium, aluminum, gallium and indium compounds and mixtures thereof (e.g., tri(n-butyl)ammonium tetrakis(pentafluorophenyl)boron and/or trisperfluorophenyl boron metalloid precursors). The three substituent groups are each independently selected from alkyls, alkenyls, halogen, substituted alkyls, aryls, arylhalides, alkoxy and halides. In one non-limiting embodiment, the three groups are independently selected from the group of halogen, mono or multicyclic (including halosubstituted) aryls, alkyls, alkenyl compounds and mixtures thereof. In another embodiment, the three groups are selected from the group alkenyl groups having 1 to 20 carbon atoms, alkyl groups having 1 to 20 carbon atoms, alkoxy groups having 1 to 20 carbon atoms, aryl groups having 3 to 20 carbon atoms (including substituted aryls) and combinations thereof. In yet another embodiment, the three groups are selected from the group of alkyls having 1 to 4 carbon groups, phenyl, naphthyl and mixtures thereof. In yet another embodiment, the three groups are selected from the group of highly halogenated alkyls having 1 to 4 carbon groups, highly halogenated phenyls, highly halogenated naphthyls and mixtures thereof. By “highly halogenated”, it is meant that at least 50% of the hydrogens are replaced by a halogen group selected from fluorine, chlorine and bromine. In yet another embodiment, the neutral stoichiometric activator is a tri-substituted Group 13 compound comprising highly fluorided aryl groups, the groups being highly fluorided phenyl and highly fluorided naphthyl groups.

The activators may or may not be associated with or bound to a support, either in association with the catalyst component (e.g., metallocene) or separate from the catalyst component, such as described by Gregory G. Hlatky, Heterogeneous Single-Site Catalysts for Olefin Polymerization 100(4) CHEMICAL REVIEWS 1347-1374 (2000).

Metallocene catalysts may be supported or unsupported. Typical support materials may include, but are not necessarily limited to, talc, inorganic oxides, clays and clay minerals, ion-exchanged layered compounds, diatomaceous earth compounds, zeolites or a resinous support material, such as a polyolefin.

Specific inorganic oxides include, but are not necessarily limited to, silica, alumina, magnesia, titania and zirconia, for example. The inorganic oxides used as support materials may have an average particle size of from 30 microns to 600 microns or from 30 microns to 100 microns, a surface area of from 50 m²/g to 1,000 m²/g or from 100 m²/g to 400 m²/g and a pore volume of from 0.5 cc/g to 3.5 cc/g or from 0.5 cc/g to 2 cc/g. Desirable methods for supporting metallocene ionic catalysts are described in U.S. Pat. Nos. 5,643,847; 6,228,795 and 6,143,686, which are incorporated by reference herein.

Polymerization Processes

As indicated elsewhere herein, catalyst systems are used to make polyolefin compositions. Once the catalyst system is prepared, as described above and/or as known to one skilled in the art, a variety of processes may be carried out using that composition. Among the varying approaches that may be used include, but are not necessarily limited to, procedures set forth in U.S. Pat. No. 5,525,678, incorporated by reference herein. The equipment, process conditions, reactants, additives and other materials will of course vary in a given process, depending on the desired composition and properties of the polymer being formed. For example, the processes of U.S. Pat. Nos. 6,420,580; 6,380,328; 6,359,072; 6,346,586; 6,340,730; 6,339,134; 6,300,436; 6,274,684; 6,271,323; 6,248,845; 6,245,868; 6,245,705; 6,242,545; 6,211,105; 6,207,606; 6,180,735 and 6,147,173 may be used and are incorporated by reference herein.

The catalyst systems described above may be used in a variety of polymerization processes, over a wide range of temperatures and pressures. The temperatures may be in the range of from about 60° C. to about 280° C., or from about 50° C. to about 200° C. and the pressures employed may be in the range of from 1 atmosphere to about 500 atmospheres or higher (about 0.1 MPa to about 50.7 MPa).

Polymerization processes may include solution, gas phase, slurry phase, high pressure processes or a combination thereof.

In certain embodiments, the process herein is directed toward a solution, high pressure, slurry or gas phase polymerization process of one or more olefin monomers having from 2 to 30 carbon atoms, or from 2 to 12 carbon atoms or from 2 to 8 carbon atoms, such as ethylene, propylene, butane, pentene, methylpentene, hexane, octane and decane. Other monomers include, but are not necessarily limited to, ethylenically unsaturated monomers, diolefins having from 4 to 18 carbon atoms, conjugated or nonconjugated dienes, polyenes, vinyl monomers and cyclic olefins. Non-limiting monomers may include norbornene, norbornadiene, isobutylene, isoprene, vinylbenzocyclobutane, sytrenes, alkyl substituted styrene, ethylidene norbomene, dicyclopentadiene, and cyclopentene.

In one non-limiting embodiment, a copolymer is produced, such as propylene/-ethylene, or a terpolymer is produced. Examples of solution processes are described in U.S. Pat. Nos. 4,271,060; 5,001,205; 5,236,998 and 5,589,555, which are incorporated by reference herein.

One example of a gas phase polymerization process generally employs a continuous cycle, wherein a cycling gas stream (otherwise known as a recycle stream or fluidizing medium) is heated in a reactor by heat of polymerization. The heat is removed from the recycle stream in another part of the cycle by a cooling system external to the reactor. The gaseous stream containing one or more monomers may be continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,456,471; 5,462,999; 5,616,661 and 5,668,228, which are incorporated by reference herein.)

The reactor pressure in a gas phase process may vary from about 100 psig to about 500 psig (about 0.7 to about 3.4 MPa), or from about 200 psig to about 400 psig or from about 250 psig to about 350 psig (about 1.7 to about 2.4 MPa), for example. The reactor temperature in a gas phase process may vary from about 30° C. to about 120° C., or from about 60° C. to about 115° C., or from about 70° C. to about 110° C. or from about 70° C. to about 95° C. Other gas phase processes contemplated by the process includes those described in U.S. Pat. Nos. 5,627,242; 5,665,818 and 5,677,375, which are incorporated by reference herein.

Slurry processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components may be separated from the polymer and recycled, optionally after a distillation, to the reactor. The liquefied diluent employed in the polymerization medium is typically an alkane having from 3 to 7 carbon atoms, such as a branched alkane. The medium employed is generally liquid under the conditions of polymerization and relatively inert. Such as hexane or isobutene.

In a specific embodiment, a slurry process or a bulk process (e.g., a process without a diluent) may be carried out continuously in one or more loop reactors. The catalyst, as a slurry or as a dry free flowing powder, may be injected regularly to the reactor loop, which may itself be filled with circulating slurry of growing polymer particles in a diluent. Hydrogen, optionally, may be added as a molecular weight control. The reactor may be maintained at a pressure of from about 27 bar to about 45 bar and a temperature of from about 38° C. to about 121° C., for example. Reaction heat may be removed through the loop wall since much of the reactor is in the form of a double-jacketed pipe. The slurry may exit the reactor at regular intervals or continuously to a heated low pressure flash vessel, rotary dryer and a nitrogen purge column in sequence for removal of the diluent and all unreacted monomer and comonomers. The resulting hydrocarbon free powder may then be compounded for use in various applications. Alternatively, other types of slurry polymerization processes may be used, such stirred reactors is series, parallel or combinations thereof.

It is known that an increase in the molecular weight normally improves the physical properties of polyethylene resins, and thus there is a strong demand for polyethylene having high molecular weight. However, it is the high molecular weight molecules, which render the polymers more difficult to process. On the other hand, a broadening in the molecular weight distribution tends to improve the flow of the polymer when it is being processed at high rates of shear. Accordingly, in applications requiring a rapid transformation employing quite high inflation of the material through a die, for example in blowing and extrusion techniques, the broadening of the molecular weight distribution permits an improvement in the processing of polyethylene at high molecular weight (this being equivalent to a low melt index, as is known in the art). It is known that when the polyethylene has a high molecular weight and also a broad molecular weight distribution, the processing of the polyethylene is made easier as a result of the low molecular weight portion and also the high molecular weight portion contributes to a good impact resistance for the polyethylene film. A polyethylene of this type may be processed utilizing less energy with higher processing yields.

The molecular weight distribution may be completely defined by means of a curve obtained by gel permeation chromatography. Generally, the molecular weight distribution is defined by a parameter, known as the dispersion index D, which is the ratio between the average molecular weight by weight (Mw) and the average molecular weight by number (Mn). The dispersion index constitutes a measure of the width of the molecular weight distribution.

It is known in the art that it is not possible to prepare a polyethylene having a broad molecular weight distribution and the required properties simply by mixing polyethylenes having different molecular weights. As discussed above, high density polyethylene consists of high and low molecular weight fractions. The high molecular weight fraction provides good mechanical properties to the high density polyethylene and the low molecular weight fraction is required to give good processability to the high density polyethylene, the high molecular weight fraction having relatively high viscosity which can lead to difficulties in processing such a high molecular weight fraction. In a bimodal high density polyethylene, the mixture of the high and low melting weight fractions is adjusted as compared to a monomodal distribution so as to increase the proportion of high molecular weight species in the polymer. This can provide improved mechanical properties.

It is thus understood that it is desirable to have a bimodal distribution of molecular weight in the high density polyethylene. For a bimodal distribution a graph of the molecular weight distribution as determined for example by gel permeation chromatography, may for example include in the curve a “shoulder” on the high molecular weight side of the peak of the molecular weight distribution.

The manufacture of bimodal polyethylene is known in the art. It is known that in order to achieve a bimodal distribution, which reflects the production of two polymer fractions, having different molecular weights, two catalysts are required which provide two different catalytic properties and establish two different active sites. Those two sites in turn catalyze two reactions for the production of the two polymers to enable the bimodal distribution to be achieved. Currently, as has been known for many years, the commercial production of bimodal high density polyethylene is carried out by a two step process, using two reactors in series. In the two step process, the process conditions and the catalyst can be optimized in order to provide a high efficiency and yield for each step in the overall process.

It is known to use a Ziegler-Natta catalyst to produce polyethylene having a bimodal molecular weight distribution in a two stage polymerization process in two liquid full loop reactors in series. In the polymerization process, the comonomer is fed into the first reactor and the high and low molecular weight polymers are produced in the first and second reactors respectively. The introduction of comonomer into the first reactor leads to the incorporation of the comonomer into the polymer chains in turn leading to the relatively high molecular weight fraction being formed in the first reactor. In contrast, no comonomer is deliberately introduced into the second reactor and instead a relatively higher concentration of hydrogen is present in the second reactor to enable the low molecular weight fraction to be formed therein. In the alternative, another example of a multiple loop process that can employ the present methods and additives is a double loop system in which the first loop produces a polymerization reaction in which the resulting polyolefin has a lower MW than the polyolefin produced from the polymerization reaction of the second loop, thereby producing a resultant resin having broad molecular weight distribution and/or bimodal characteristics.

Further details about the production of bimodal or multimodal resins may be found in U.S. Pat. No. 6,221,982 and U.S. patent application Ser. No. 10/667,578, now allowed, published as U.S. Patent Application Publication 2004/0058803 A1, incorporated in its entirety by reference herein.

Polymer Product

The polymers produced by the processes described herein may be used in a wide variety of products and end-use applications. The polymers may include linear low density polyethylene, elastomers, plastomers, high density polyethylenes, low density polyethylenes, medium density polyethylenes, polypropylene and polypropylene copolymers.

Further, the process may include coextruding additional layers to form a multiplayer film. The additional layers may be any coextrudable, film known in the art, such as, low density polyethylene, linear low density polyethylene, medium density polyethylene, high density polyethylene, ethylene-propylene copolymers, butylenes-propylene copolymers, ethylene-butylene copolymers, ethylene-propylene-butylene terpolymers, ethylene-vinyl acetate copolymers, ethylene-vinyl alcohol copolymers, nylons etc.

In order to modify or enhance certain properties of the films for specific end-uses, it is possible for one or more of the layers to contain appropriate additives in effective amounts. The additives may be employed either in the application phase or may be combined with the polymer during the processing phase (pellet extrusion), for example. Such additives may include, but are not necessarily limited to, stabilizers (e.g., phosphates, phosphites, and other stabilizers known to those skilled in the art) to protect against UV degradation, thermal or oxidative degradation and/or actinic degradation and other forms of degradation, antistatic agents (e.g., medium to high molecular weight polyhydric alcohols and tertiary amines), anti-blocks, anti-oxidants, coefficient of friction modifiers, processing aids, colorants, clarifiers and other additives known to those skilled in the art.

Color Reducing Additives

It has been discovered that the use of certain additives reduces yellow color in polyethylene that is extruded with radical initiators. As noted elsewhere peroxides and sometimes oxygen are added in order to increase the blown film bubble stability of bimodal polyethylene material, as well as to induce LCB and to improve processing performance. In one non-limiting embodiment, the proportion range of oxygen and/or peroxide may be from 5 to 100 ppm, based on the total resin, alternatively from about 10 to 30 ppm. Suitable color reducing additives include, but are not necessarily limited to, polyethylene glycol (PEG), alcohols, glycols, polyols, and/or water and neutralizing species such as a stearate, e.g. calcium stearate, and zinc oxide.

When a polyethylene is extruded with radical initiators, the Yellow Index (YI) of the polymer may be reduced by using one or more the following approaches. The incorporation of PEG, alcohols, glycols, polyols, and/or water in the free radical-modified material reduces the YI. For instance, adding 200 ppm of PEG in a bimodal polyethylene with 10 ppm of peroxide allowed reducing the color by several points on the YI scale. Water may be introduced as steam. More specifically, the PEG, alcohols, glycols, polyols may include, but are not necessarily limited to, PEG, sorbitol, mannitol, glycerol and water steam. Where the color-reducing additive is a PEG, alcohol, glycol, polyol, and/or water steam, the proportion of additive ranges from about 5 to 1000 ppm, based on the polymerization mixture, in one non-limiting embodiment, and alternatively ranges from about 100 to 300 ppm.

Further, the radical initiators introduced in the polyethylene material may react with some residues formed before the extrusion process to form yellow species. It has been found that when an appropriate type of chemical is used to neutralize these residues, the color of the resulting polyethylene is significantly reduced. Specifically, adequate amounts of neutralizing species including, but are not necessarily limited to, calcium stearate or zinc oxide may decrease the color of a bimodal polyethylene modified in extrusion by radical initiator (e.g. oxygen or peroxides). In one non-restrictive instance, adding 1000 ppm of calcium stearate in a bimodal polyethylene modified with peroxide allowed reducing the yellow index from a positive 4 to a negative 0.5 on the YI scale.

Additional color-reducing additives include, but are not necessarily limited to, neutralizing species including alkali metal stearates, alkali earth metal stearates and zinc stearate, more specifically including, but not necessarily limited to, calcium stearate, magnesium stearate, zinc stearate, sodium stearate, potassium stearate, and mixtures thereof. In the case of the additive being stearate, the proportion of stearate used may range from about 300 to about 2000 ppm based on the polymerization mixture in one non-limiting embodiment, and alternatively may range from about 500 to about 1500 ppm.

In the case of the additive neutralizing species being zinc oxide, the proportion of zinc oxide used may range from about 300 to about 4000 ppm based on the polymerization mixture in one non-limiting embodiment, and alternatively may range from about 1000 to about 4000 ppm. It will be appreciated that the resulting polyethylene article, film or sheet material will have reduced color as compared with an identical polyethylene article, film or sheet material absent the additive.

Although the methods and compositions will be described herein with respect to high density polyethylene (HDPE), it will be appreciated that the teachings may be applied to other polymers, particularly other polyethylenes including, but not necessarily limited to medium density polyethylene (MDPE), low density polyethylene (LDPE), linear low density polyethylene (LLDPE), and the like.

The present methods and compositions are directed to applications of polyethylene resins in one particular embodiment, and in a particular non-limiting embodiment high density polyethylene (HDPE), and especially HDPE blown and extruded films, although the methods and compositions could be applied to HDPE blow-molded articles. The polyethylene resins herein may be applied in any “free surface” application, by which is meant any extrusion/molding process where the polymer exits a die and is for a brief period unconstrained before being molded or formed into a product. Thus, free surface applications include, but are not necessarily limited to, film blowing and extrusion, sheet extrusion, blow-molding, coating, etc. In one non-limiting embodiment, the HDPE resin herein is a high molecular weight HDPE (HMW-HDPE) homopolymer having a broad or narrow molecular weight distribution (MWD), and low shear thinning behavior.

As noted, the methods and compositions herein are expected to find particular application to branched HDPE homopolymers or copolymers, which may contain catalyst residues that may react and cause undesirable color in the resin, although it should be understood that the methods and compositions herein are not bound by any theory that color is caused by catalyst residue. The compositions and methods herein are expected to find particular use in polyethylenes which have had long chain branching (LCB) induced particularly by oxygen and peroxides). In one non-limiting embodiment herein, the base resin herein is very similar to those film grade resins described in U.S. patent application Ser. No. 09/896,917 (published as 2003/0030174) and U.S. Pat. No. 6,777,520, both filed Jun. 29, 2001, hereby incorporated by reference.

Generally, and in a more specific non-limiting embodiment, the MWD of the HDPE herein is about 15 or above. In one non-limiting alternative, the MWD is possibly between about 19 to about 23. The inventive concept herein is generally independent of density, however. In the context herein, the MWD refers to the MWD of a unimodal resin, or in the case of a bimodal resin refers to the MWD of the combined low and high molecular weight peaks thereof. It will be appreciated that the inventive methods and compositions herein are not limited to whether the resin is unimodal or bimodal.

In one non-limiting embodiment, the density of the HDPE may be between 0.947 and 0.957 g/cm³, inclusive, and in another non-limiting, alternate embodiment may be between 0.950 and 0.954 g/cm³. The HDPE generally has a melt index (MI₂) in the range of about 0.02 dg/min to about 0.5 dg/min, in one non-limiting, alternate embodiment from about 0.07 dg/min to about 0.3 dg/min, and in a further non-limiting, alternate embodiment from about 0.08 dg/min to about 0.25 dg/min. The HDPE is stable upon extrusion.

With respect to the non-limiting embodiment where the HDPE is high molecular weight (MMW) high density polyethylene (HDPE), the polyethylene is also made using catalysts already described and techniques already described or well known in the art. By “high molecular weight” is meant a molecular weight ranging from about 200,000-300,000 Mw or higher, and alternatively in another non-limiting embodiment ranging from about 240,000 Mw or higher. The melt flow index (MFI) at 190° C., 2.16 kg may range from about 0.04 to about 0.1 g/10 min, and alternatively from about 0.06 to about 0.08 g/10 min. The melting point of the HDPE may range from about 115 to about 135° C. in one non-limiting embodiment, and alternatively from about 120 to about 130° C. Suitable ZN HDPEs include, but are not necessarily limited to, high molecular weight bimodal HDPE available from TOTAL® Petrochemicals Inc. A proprietary catalyst system is used to manufacture HMW-HDPE film grades with exceptional properties including, but not necessarily limited to, low haze, high gloss, extremely low gel content and low taste and odor.

Another embodiment provides a process for polymerization of α-olefin monomers, wherein the monomers are generally ethylene. The polymerization process may be bulk, slurry or gas phase, although in one non-limiting embodiment, a slurry phase polymerization may be used, and in another non-limiting, alternate embodiment one or more loop reactors may be employed.

The reactor temperature is generally a temperature in the range of about 180(F. to about 230(F. (about 82 to about 110(C.). In another non-limiting, alternative embodiment, the reactor temperature is in the range of about 190(F. to about 225(F. (about 88 to about 107(C.), and in yet another non-limiting, alternative in the range of about 200(F. to about 220(F. (about 93 to about 104(C.). In one non-limiting embodiment, the aluminum cocatalyst levels may generally be in the range of about 10 ppm to about 300 ppm with respect to the diluent. In another non-restrictive embodiment, the cocatalyst levels are in the range of about 50 ppm to about 200 ppm with respect to the diluent, and in an alternate non-limiting embodiment are in the range of about 25 ppm to about 150 ppm.

The olefin monomer may be introduced into the polymerization reaction zone in a nonreactive heat transfer diluent agent that is liquid at the reaction conditions. Examples of such a diluent include, but are not necessarily limited to, hexane and isobutane. In one non-limiting embodiment, the diluent is isobutane.

Generally the polymer produced herein involves copolymerization of ethylene with another alpha-olefin, such as, for example, propylene, butene or hexene, the second alpha-olefin may be present at about 0.01-20 mole percent, in another non-limiting embodiment from about 0.02-10 mole percent.

It should be understood that peroxides and/or air are to be employed carefully to maintain control of the resin characteristics and ultimate film. It has been discovered that a resin additive such as peroxide and/or air (oxygen) may provide the necessary LCB needed to make a more processable material. In one non-limiting embodiment, the peroxide proportion ranges from about 2 to about 100 ppm by weight, based on the total resin. In an alternate non-limiting embodiment, the peroxide proportion may range from about 10 to about 100 ppm, alternatively from about 30 to about 60 ppm by weight, based on the total resin.

In one non-limiting embodiment, suitable oxidizing agents include, but are not necessarily limited to, hydrogen peroxide, oxygen, peroxides, peroxyketals, peroxyesters, and dialkyl peroxides such as LUPERSOL® 101 (available from ARKEMA).

As noted, materials that are altered via radical degradation may undergo very significant changes in rheology. It is necessary to control these changes. One control is made using an online or offline rheometer that analyzes the flow of the material and provides feedback to adjust extrusion parameters to achieve the desired rheology.

In the present invention, energy measurements on the extruder and on the gear pump are used to acquire feedback information on the material rheology. It has been discovered that the Specific Energy Input (SEI) response of a material to a throughput variation is linear. The position of the line depends on the rheology of the material. A particular material of constant powder melt index (MI) but with various levels of LCB will exhibit different SEI responses to the throughput variation.

The advantages of the method include, but are not necessarily limited to:
1. The possibility of controlling rheology online.
2. No extra investment (no additional rheometer) is or would be required, beyond what is typically or conventionally used.
3. Instant feedback by reading extrusion parameters is available.
4. It is possible to tie the extrusion parameter feedback into an Advanced Process Control (APC) system and have automatic adjustment of LCB.
5. As a result of the above advantages, better product consistency would result.

In more detail, in attempts to develop a quality control (QC) test to control the HDPE rheology, in particular high molecular weight bimodal HDPE rheology it was discovered that relations existed between extruder parameters and the amount of Long Chain Branching (LCB) occurring in the polyethylene resin material. The study of the extruder output readings during six commercial high molecular weight bimodal HDPE runs with various levels of peroxides and various Theological breadth revealed two possibilities to predict LCB in this HDPE. Both solutions are related to energy measurements in the extruder. As the level of LCB increases in a material, the viscosity at low shear rates is enlarged and the energy required to transfer the melt to the die is also raised.

The first method consists in measuring the rotor SEI response with throughput variation. This method allows observing significant differences in rheology during each single run. There is a limitation in this method however; some significant noise is measured in the SEI to throughput response of materials with similar rheology but from different runs. The reproducibility of this technique is moderate from run to run.

The second method involves measuring the gear pump (GP) SEI/pressure ratio with throughput variation. It was discovered that the correlations for this method are very linear. Significant differences are observed when the amount of LCB is changed within a production run. In 80% of the instances, materials from different runs with the same breadth parameters exhibit the same GP SEI/pressure response. In a final check, very significant differences were observed between the high molecular weight bimodal HDPE mentioned previously (HDPE A) and a second high molecular weight bimodal HDPE (HDPE B).

As a result of the efforts undertaken to provide the first high molecular weight bimodal HDPE (HDPE A) with a constant rheology, peroxide as a free radical initiator was included. An unvarying rheology is defined by two characteristics: first, within a production run, the standard deviation on the rheological parameters is low; and second, each time a new production run is started the new product is similar to that of the previous run.

The HDPE herein is stable upon extrusion and has a rheological breadth parameter greater than conventional HDPE resins. For resins with no differences in levels of long chain branching (LCB), it has been observed that the Theological breadth parameter “a” is inversely proportional to the breadth of the molecular weight distribution. Similarly, for samples that have no differences in the molecular weight distribution, the breadth parameter has been found to be inversely proportional to the level of long chain branching. An increase in the rheological breadth of a resin is therefore seen as a decrease in LCB. This correlation is a consequence of the changes in the relaxation time distribution accompanying those changes in molecular architecture. Generally, the HDPE resin herein has a Theological breadth parameter of greater than about 0.08, and in another non-limiting, alternate embodiment, greater than about 0.25, and on the other hand greater than about 0.30. Depending on starting material, the breadth parameter could range between 0.05 and 0.6. The breadth parameter is extracted from the Carreau-Yasuda (CY) model.

Effective neutralizing species include, but are not necessarily limited to, neutralizing species including alkali metal stearates, alkali earth metal stearates, and metal stearates and metal oxides. In a particular, non-limiting embodiment, the alkali earth metal stearates include calcium stearate, magnesium stearate; suitable, but non-limiting alkali metal stearates include sodium stearate and potassium stearate; suitable metal stearates include zinc stearate, and suitable, non-restrictive metal oxides include, but are not necessarily limited to zinc oxide and mixtures thereof.

In the case of the additive being a stearate, the proportion of stearate used may range from about 300 to about 2000 ppm based on the polymerization mixture in one non-limiting embodiment, and alternatively may range from about 500 to about 1500 ppm. In the case of the additive neutralizing species being a metal oxide, the proportion of metal oxide used may range from about 300 to about 4000 ppm based on the polymerization mixture in one non-limiting embodiment, and alternatively may range from about 1000 to about 4000 ppm. It will be appreciated that the resulting polyethylene resin will have more consistent rheological properties as compared with an otherwise identical polyethylene resin absent the free radical initiator and an alkali earth metal stearate.

No special technique is needed to introduce the alkali earth metal stearate to the polymerization mixture, and it is expected that the additive may be added before, during and/or after free radical initiators are introduced.

The polymers may also contain various additives capable of imparting specific properties to the articles the resins are intended to produce. Additives known to those skilled in the art that may be used in these polymers include, but are not necessarily limited to, fillers such as talc and calcium carbonate, pigments, antioxidants, stabilizers, anti-corrosion agents, slip agents, UV stabilizing agents and antiblock agents, etc.

In further processing the polymers herein may be co-extruded with other resins to form multilayer films, although it should be understood that the methods and compositions herein also apply to monolayer films as well. The co-extrusion may be conducted according to methods well known in the art. Co-extrusion may be carried out by simultaneously pushing the polymer of the skin layer and the polymer of the core layer through a slotted or spiral die system to form a film formed of an outer layer of the skin polymer and substrate layer of the core polymer. Furthermore, the film or sheet materials may be laminated with other materials after extrusion as well. Again, known techniques in laminating sheets and films may be applied to form these laminates.

Articles that may be wrapped with these co-extruded films or sheet structures include, but are not necessarily limited to, frozen foods, other foods, urban refuse, fresh cut produce, detergent bags, towel overwrap, and the like.

The methods, resins, films and structures discussed herein will now be described further with respect to actual Examples that are intended simply to further illustrate the concept and not to limit it in any way.

### EXAMPLES

Several high molecular weight bimodal HDPE plant trials using free radical initiation revealed the necessity to adjust the peroxide level at the beginning of every run to adjust the level of LCB to the desired level. This requirement raised the need to develop a QC-type test to quantify LCB without having to have all the samples analyzed. It was discovered that there was a correlation between peroxide level and some extruder readings.

### Extrusion System Energy Measurements

Materials

The data were monitored with an engineering process software and extracted for six high molecular weight bimodal HDPE plant runs produced in a January-June time Extrusion conditions included a feed rate of 42,000 to 55,000 lbs/hr (19-25 metric tons/hour), a gate position of 20%-50% even up to 60 to 70% varying to control the gate temperature from 360 to 450° F. (182 to 232° C.), and a suction pressure of 15-40 psi (0.1-0.28 MPa), unless otherwise noted.

Experimental Procedure

The data was analyzed using simple linear correlation and analysis of variance (ANOVA). Five different methods were used to attempt to correlate the material rheology with some extruder output parameters. Of these, rotor specific energy input (SEI) and ratios of gear pump SEI with screen pack pressure proved the most beneficial.

### Results

Relationship Between Rotor SEI and Material Rheology

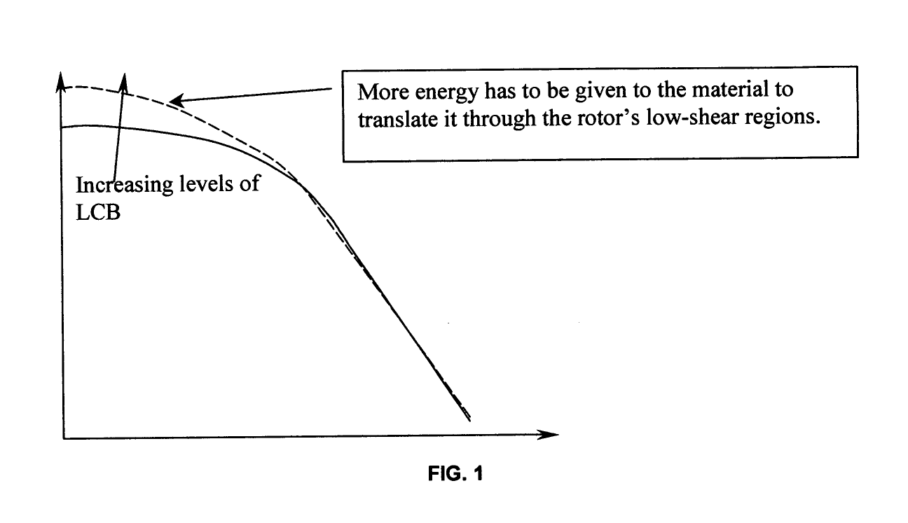

When the amount LCB in the resin material varies, the corresponding change in viscosity at low shear rates may induce differences in the energy the material absorbs during its residence in the extruder; see FIG. 1. FIG. 1 is a plot of the curve of viscosity of polyethylene resin with shear at various levels of LCB. With increasing levels of LCB, more energy must be given to the resin material to translate it through the extruder rotor's low-shear regions.

Previous research demonstrated a strong linear dependence between SEI and throughput. Within a production run, the throughput may vary between 35,000 lb/hr (16 t/hr) and 55,000 lb/hr (25 t/h). This range of variation will induce significant SEI changes. It is therefore very unlikely to observe a direct relationship between LCB levels and SEI due to the noise added by throughput variation. However, the connection between rheology and SEI could be observed by studying the evolution of linear dependence between SEI and throughput.

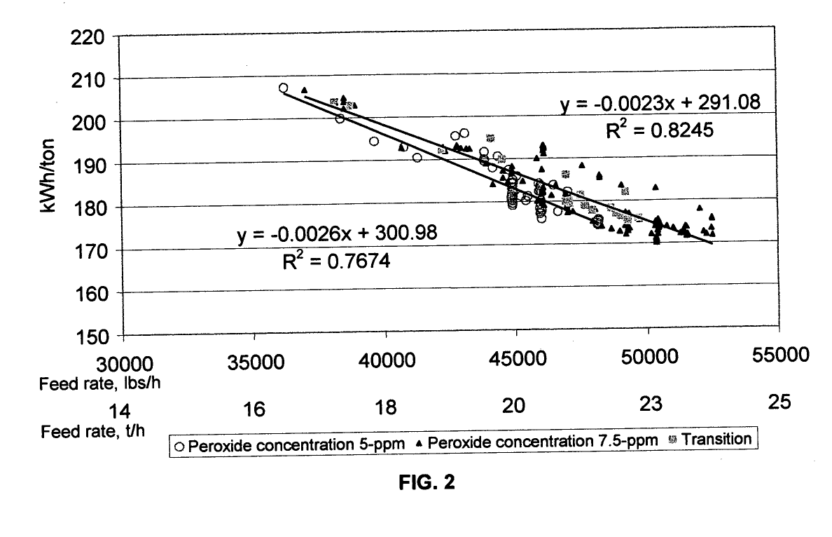

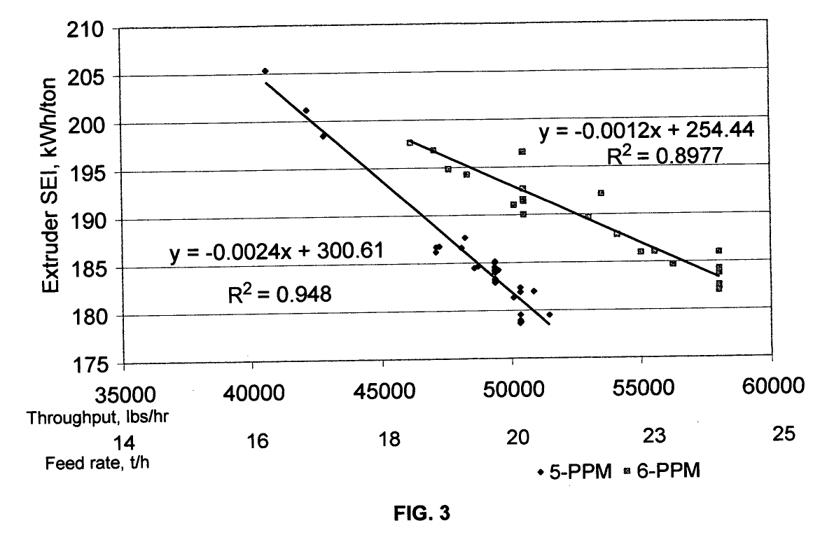

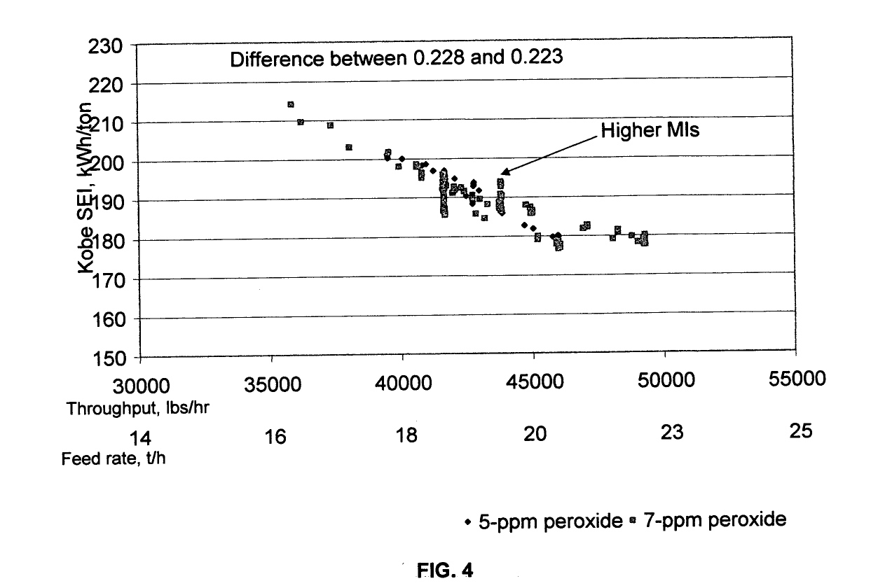

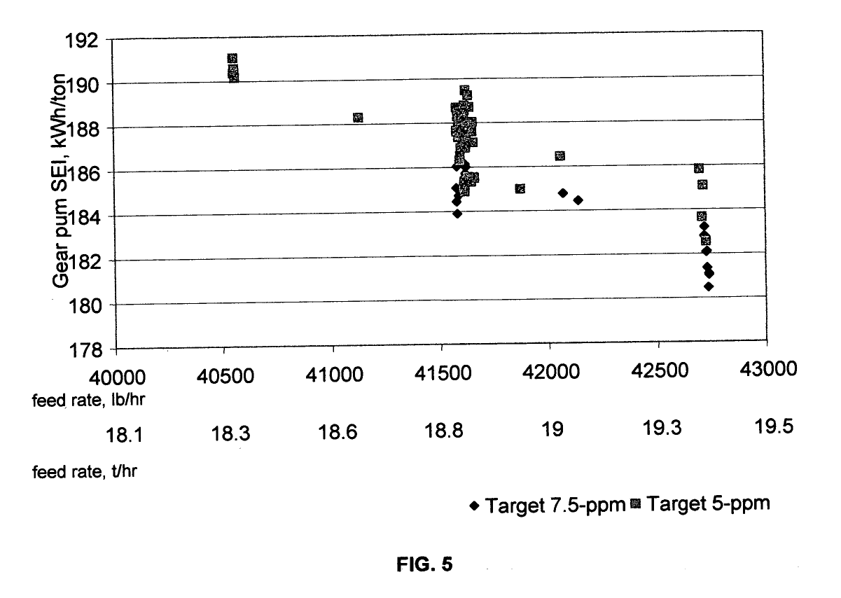

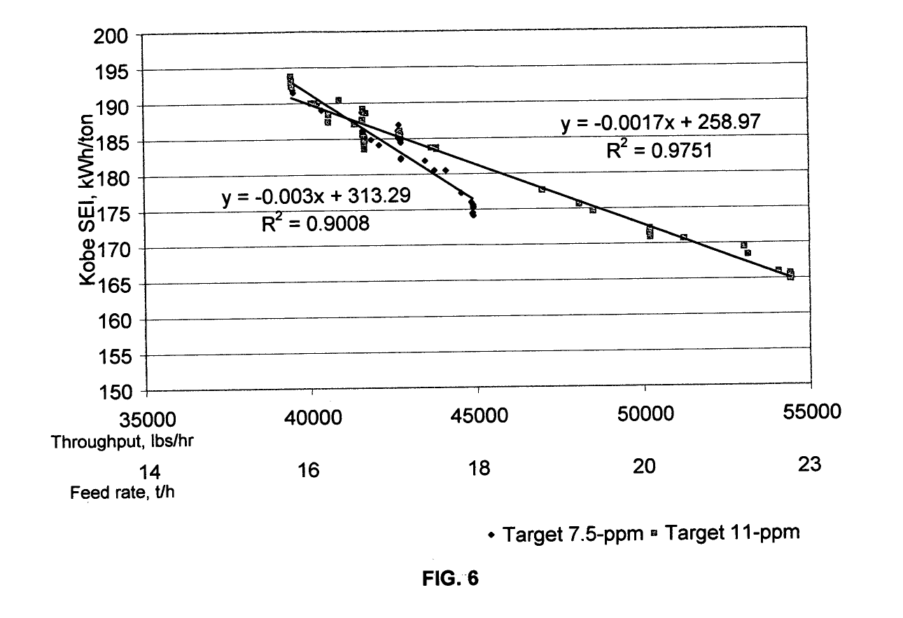

FIGS. 2 through 6 show the rotor SEI versus throughput for five production runs. In all but the March run, variation of the peroxide concentration induced significant variations of the SEI response to the throughput. When the level of LCB increased, the SEI in the extruder also increases, confirming the hypothesis formulated in the preceding paragraph. However, during the April run (FIG. 5), the material with 7.5 ppm of peroxide also had CaSt present as a neutralizer. As previously discussed, CaSt influences the peroxide effect in the material. The breadth parameter of this April material indicates lower level of LCB than the high molecular weight bimodal HDPE with 5-ppm of LUPEROX® 101 (free radical initiator available from ARKEMA) and thus requires higher rotor SEI.

The linear fit corresponding to these figures has a coefficient of determination R² between 0.6 and 0.97. Some of the low R² values indicate some significant scattering. Because of this scattering, many data points are needed to safely recognize the difference between different amounts of long chain branching. This may be a major inconvenience for a useful QC-type evaluation process in some contexts.

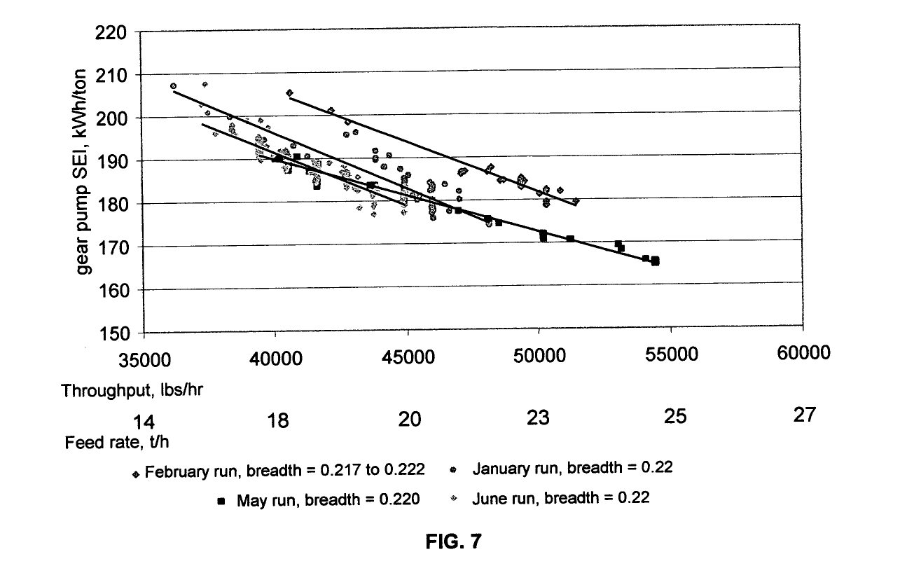

FIG. 7 shows the rotor SEI of various high molecular weight bimodal HDPE runs with similar breadth parameters. Most of the runs are on the same master curve. However, note the February run exhibits a higher SEI response to the throughput. The gate position was exceptionally closed for this run (at 20%). While previous studies showed a significant but weak correlation between SEI and gate position, that previous research was conducted at higher gate opening. It is possible that for small gate openings the influence of gate position on SEI is non-linear and more important.

Relationship Between Gear Pump (GP) SEI and Material Rheology

Previous research indicated that resin material in the gear pump is subjected to similar levels of maximal shear as in the rotor. A SEI-LCB level dependence similar to that of the rotor (see above) was hypothesized.

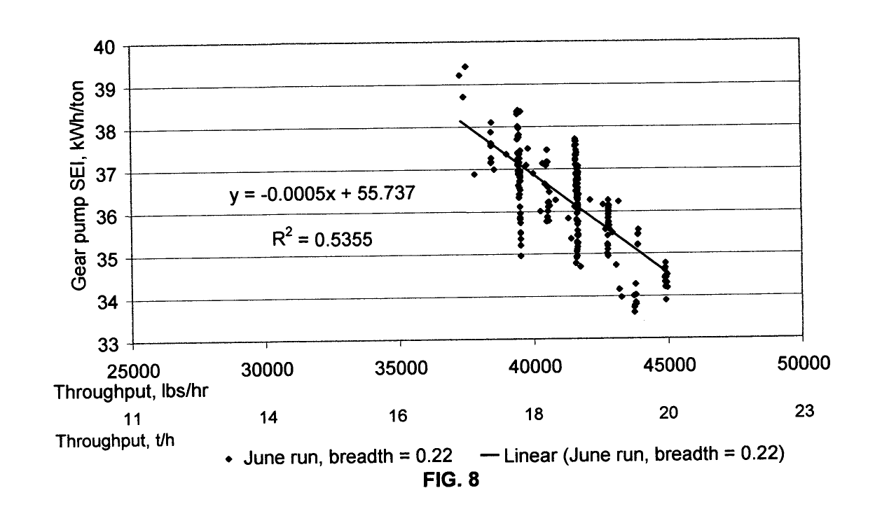

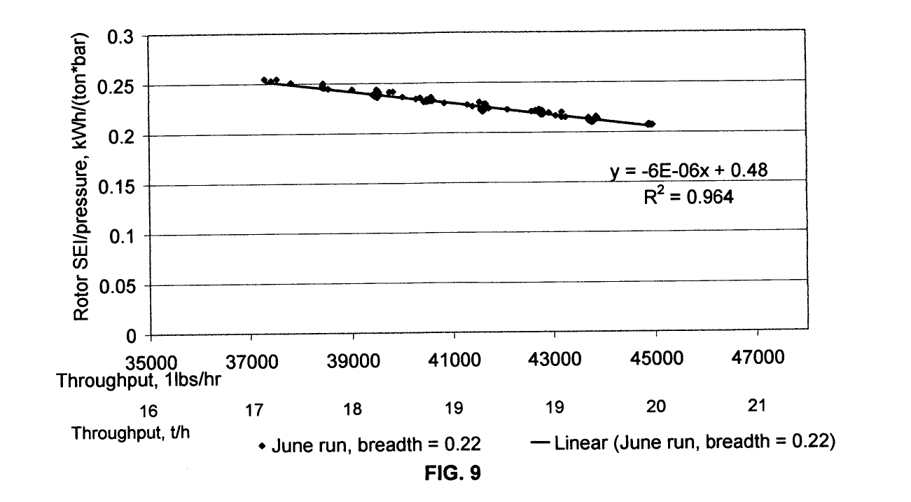

FIG. 8 displays the relationship between GP SEI and throughput. While a general trend may be observed, the expected linear correlation is very poor. FIG. 9 shows the relationship between the GP SEI divided by screen pack pressure versus the throughput. As contrasted with GP SEI alone (FIG. 8), the correspondence between these two parameters is remarkably linear with a R² above 0.96. It is believed that as the discharge orifice pressure increases, the backflow in the gear pump also increases, introducing noise in the SEI/throughput relationship. When this noise is corrected by entering the screen pack pressure into the relation, the correlation becomes very linear.

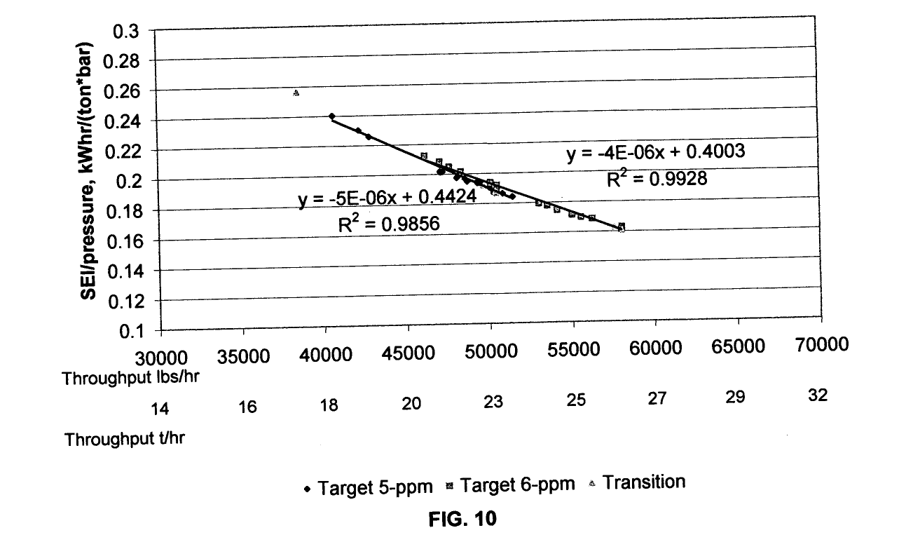

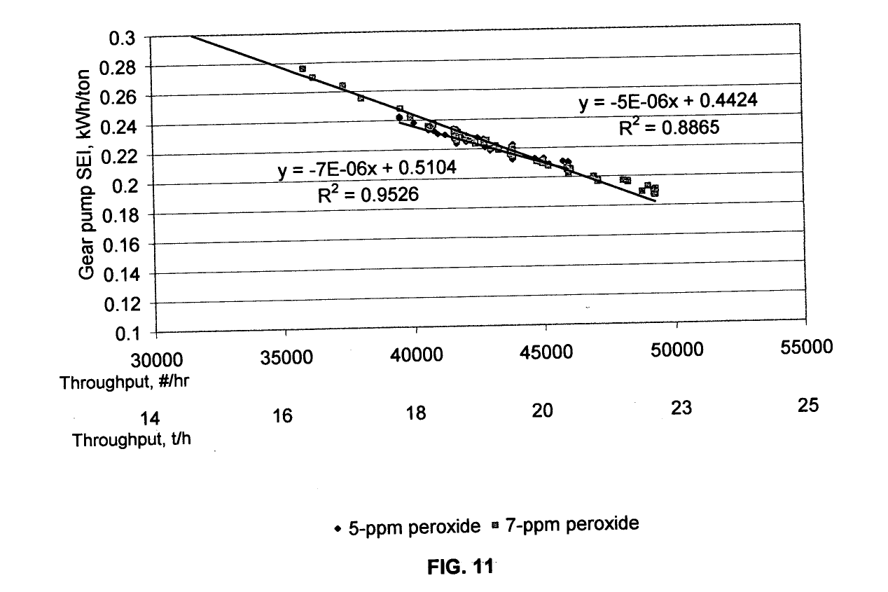

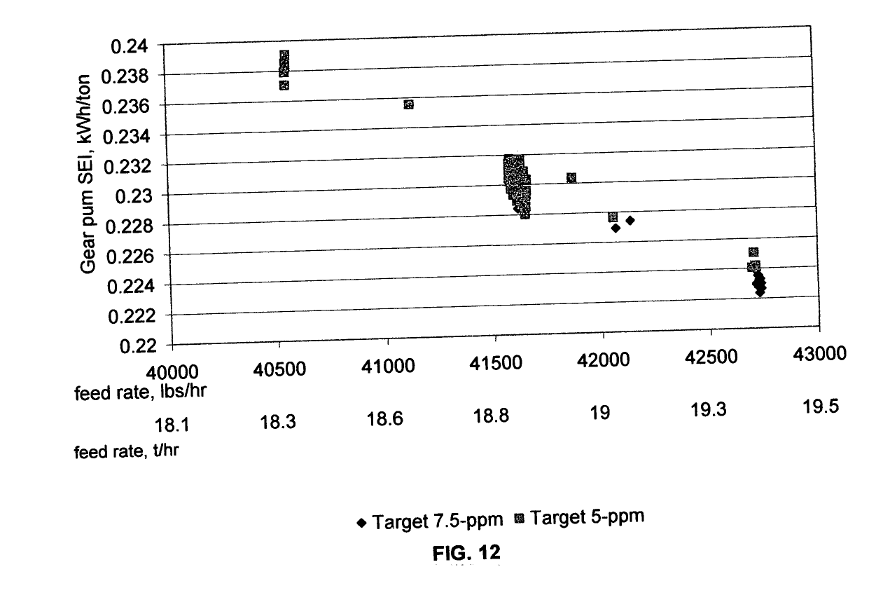

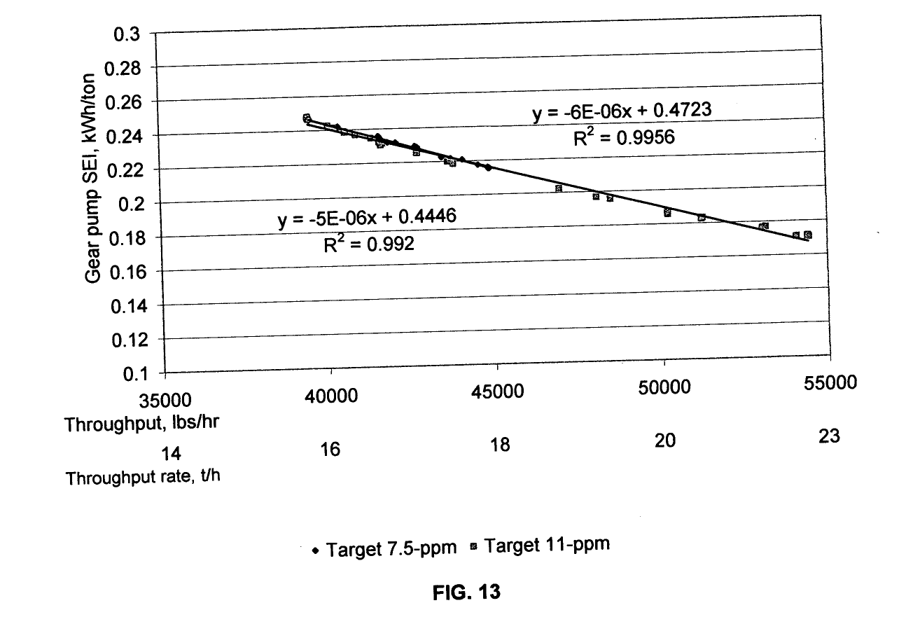

FIGS. 10 through 13 show the relation between GP SEI/pressure and throughput for four production runs that include different levels of LCB. All the correlations are linear with high R² values. Within a run, when the level of LCB increases in the material the SEI/pressure versus throughput curve increases, for similar reasons as the rotor SEI (see discussion in immediately previous section; the comment about the April data (FIG. 5) applies to FIG. 12). Some of the variations are small, but thanks to the high R² values they are significant.

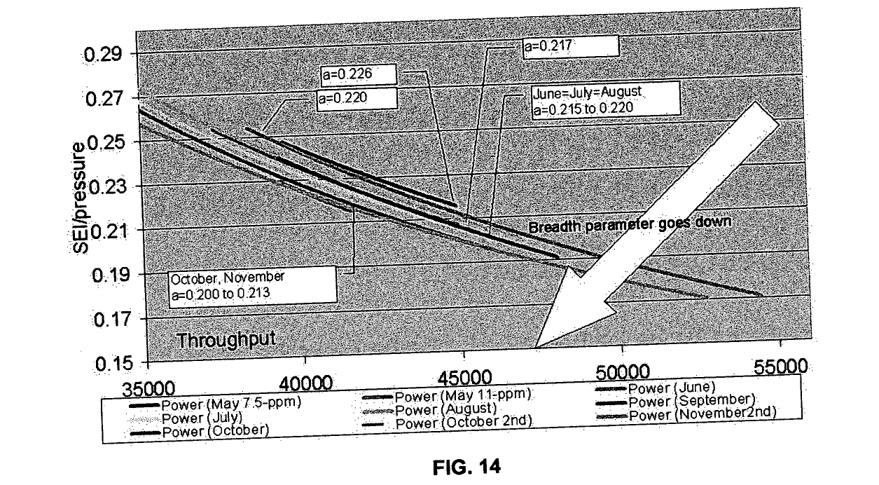

FIG. 14 shows the GP SEI/pressure versus throughput for high molecular weight bimodal HDPE material of different rheological breadths; the value of a is given for each curve. The data in FIG. 14 suggests that it is possible to predict a variation in rheology regardless of the production run or the breadth parameter, for a given material. The direction of the curves with decreasing breadth parameter is consistent, as indicated by the arrow.

The following conclusions may be drawn from the study of extrusion system energy measurements. Two methods may be used to predict the rheological behavior of polyethylenes, such as high molecular weight bimodal HDPE.

The first method involves or consists of measuring the rotor SEI response with throughput variation. This method allows observing significant differences in rheology during each single run. There is a limitation in this method however: some significant noise is measured in the SEI to throughput response of materials with similar rheology but from different runs. The reproducibility of this technique is moderate from run to run.

The second method concerns or consists of measuring the gear pump SEI/pressure ratio with throughput variation. The correlations for this method are very linear. Significant differences are observed when the amount of LCB is changed within a production run. In 75% of the instances, materials from different runs with the same breadth parameters exhibit the same GP SEI/pressure response. Further, as shown in FIG. 14, for a given material, the rheology behaves in a predictable way depending upon the breadth parameter.

### Rheological Consistency Using Free Radical Initiator and Alkali Earth Metal Stearate

Materials

The materials used in this part of the study are all high molecular weight bimodal film grades of similar melt index, using the same catalyst and cocatalyst system.

Standard Deviation of the Breadth Parameter

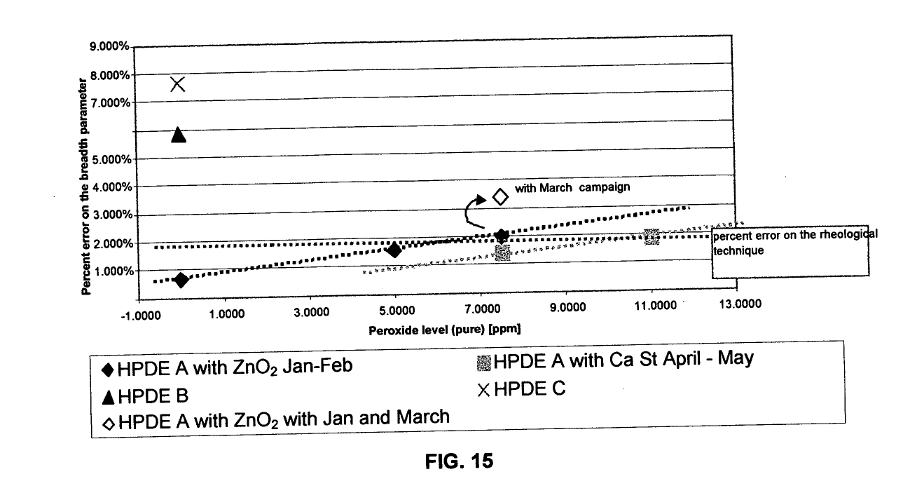

FIG. 15 exhibits the % standard deviation on the breadth parameter of several high molecular weight bimodal HDPE materials. The deviation on the high molecular weight bimodal HDPE in the previous Examples having free radical initiation (HPDE A shown as solid diamonds, hollow diamonds and gray squares) is almost one order of magnitude below that of the other high molecular weight bimodal HDPE materials without noted without free radical initiation (shown as “X”—HPDE C and triangle—HPDE B). The following observations and discoveries were made with respect to polyethylene resins and high molecular weight bimodal HDPE in particular:
1—The use of peroxide reduces the standard deviation on the breadth parameter very significantly compared to that of a product without radical initiation, as seen in FIG. 15. This observation reveals a level of LCB very constant in all lots and translates into reliable performance in term of film processing (i.e. improved bubble stability).
2—The use of peroxide reduces the standard deviation on the breadth parameter compared to that of a product of identical design using oxygen as a radical initiator, also seen in FIG. 15.
3—The combined use of peroxide and calcium stearate as a neutralizer in a resin reduces the standard deviation on the breadth parameter compared to that of a product using peroxide and zinc oxide.
4—The combined use of peroxide and calcium stearate (CaSt) as a neutralizer allows achieving significant increases in product consistency between each production run as compared to using zinc oxide. Each run of material using CaSt and peroxide exhibits the same breadth parameter (and thus LCB level), while in contrast, adjustments had to be made on peroxide levels at the start of every run using zinc oxide to keep the rheological breadth on target.
   The deviation of high molecular weight bimodal HDPE A with CaSt (squares) is lower than that of this high molecular weight bimodal HDPE A with zinc oxide (diamonds). The previous high molecular weight bimodal HDPE material with CaSt has the most regular amount of LCB among the lots measured in FIG. 15.
   Consistency Between Runs

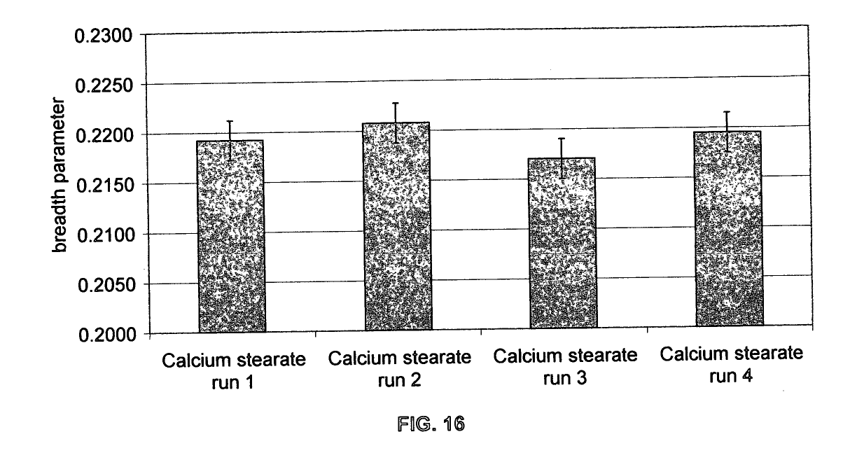

FIG. 16 exhibits the breadth parameter of various high molecular weight bimodal HDPE runs using CaSt and 11-ppm of peroxide. The breadth parameter is within standard deviation for each run. The amount of LCB is consistent for each production campaign. No peroxide concentration adjustments are necessary to achieve outstanding consistency during each production run.

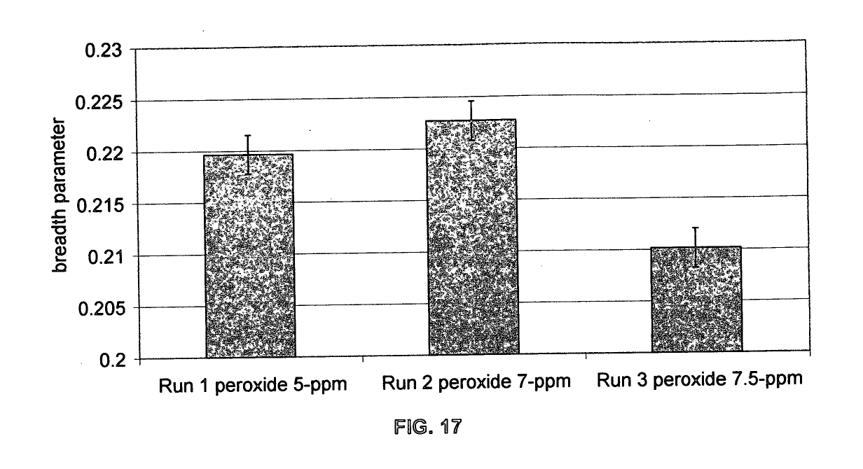

FIG. 17 exhibits the breadth parameter of several high molecular weight bimodal HDPE runs using zinc oxide. One run using 7-ppm peroxide shows a breadth parameter higher than a run using only 5-ppm. This is unexpected as the breadth parameter should decrease with peroxide concentration increasing. One run with 7.5-ppm peroxide exhibits a very low breadth parameter compared to a run with 7-ppm despite of virtually identical concentrations. The breadth parameter and thus the amount of LCB in the materials vary from run to run when zinc oxide is used as a neutralizer as contrasted with the case where CaSt and a free radical initiator are used (see FIG. 16). The variation remains unexplained but could be connected to changes in extrusion conditions, without wishing to be limited to any particular explanation. As a result of this behavior the first few lots of each production campaign using zinc oxide may have to be analyzed and the peroxide concentration adjusted to reach the breadth target. This is further confirmation of the uniqueness of the consistency achieved by using a free radical initiator and an alkali earth metal stearate, as contrasted with using only zinc oxide.

In the foregoing specification, the films, components and methods have been described with reference to specific embodiments thereof, and have been demonstrated as effective in providing methods for preparing polyethylene having improved rheology, in particular improved control and consistency. However, it will be evident that various modifications and changes may be made thereto without departing from the scope of the invention as set forth in the appended claims. Accordingly, the specification is to be regarded in an illustrative rather than a restrictive sense. For example, specific combinations or proportions of monomers, free radical initiators, neutralizing species, additives and other components falling within the claimed parameters, but not specifically identified or tried in a particular polyethylene, are anticipated and expected to be within the scope of this invention. Further, these methods are expected to work at other conditions, particularly extrusion and blowing conditions, than those exemplified herein.

What is claimed is:

1. A method for controlling the rheology of polyethylene comprising:
polymerizing ethylene monomer;
extruding the polyethylene resin with an extruder; and
controlling the rheology of polyethylene resin by a process selected from the group consisting of:
measuring the specific energy input (SEI) to the extruder and adjusting a process parameter in response to a change in SEI;
adjusting the process parameter selected from the group consisting of introducing a free radical initiator, introducing a neutralizing species selected from the group consisting of an alkali metal stearate, an alkali earth metal stearate, a metal stearate and a metal oxide, into the polymerization mixture, and both.

2. The method of claim 1 where the free radical initiator is selected from the group consisting of oxygen, peroxides, peroxyketals, peroxyesters, and dialkyl peroxides.

3. The method of claim 1 where the neutralizing species is an alkali earth metal stearate.

4. The method of claim 1 where the SEI is measured and the process parameter adjusted is selected from the group consisting of the proportion of free radical initiator, the proportion of an alkali earth metal stearate introduced into the polymerization mixture and both.

5. The method of claim 1 where a rotor SEI is measured.

6. The method of claim 1 where a ratio of gear pump SEI to pressure is measured.

7. The method of claim 1 where the rheological consistency of the polyethylene resin is improved by the method as compared to a method otherwise identical except that the rheology is not controlled as in claim 1.

8. The method of claim 1 where the long chain branching (LCB) of the polyethylene resin is controlled as compared to a method otherwise identical except that the rheology is not controlled as in claim 1.

9. The method of claim 1 further comprising blowing a film of the polyethylene.

10. A method for controlling the rheology of polyethylene comprising:
polymerizing ethylene monomer;
extruding the polyethylene resin with an extruder; and
controlling the rheology of polyethylene resin by:
measuring the specific energy input (SEI) to the extruder and
adjusting a process parameter selected from the group consisting of introducing a free radical initiator selected from the group consisting of oxygen, peroxides, peroxyketals, peroxyesters, and dialkyl peroxides, and introducing a neutralizing species selected from the group consisting of an alkali metal stearate, an alkali earth metal stearate, a metal stearate and a metal oxide into the polymerization mixture and both,
where the rheological consistency of the polyethylene resin is improved by the method as compared to a method otherwise identical except that the rheology is not controlled.

11. The method of claim 10 where the neutralizing species is an alkali earth metal stearate.

12. The method of claim 10 where the long chain branching (LCB) of the polyethylene resin is controlled by the method as compared to a method otherwise identical except that the rheology is not controlled as in claim 1.

13. The method of claim 10 further comprising blowing a film of the polyethylene.

14. A polyethylene resin having a controlled rheology made by a method comprising:
polymerizing ethylene monomer as a polymerization mixture;
extruding the polyethylene resin with an extruder; and
controlling the rheology of polyethylene resin by a process selected from the group consisting of:
measuring the specific energy input (SEI) to the extruder and adjusting a process parameter in response to a change in SEI;
adjusting the process parameter selected from the group consisting of introducing a free radical initiator, introducing a neutralizing species selected from the group consisting of an alkali metal stearate, an alkali earth metal stearate, a metal stearate and a metal oxide into the polymerization mixture, and both.

15. The polyethylene resin of claim 14 where the free radical initiator is selected from the group consisting of oxygen, peroxides, peroxyketals, peroxyesters, and dialkyl peroxides.

16. The polyethylene resin of claim 14 where the neutralizing species is an alkali earth metal stearate.

17. The polyethylene resin of claim 14 where the SEI is measured and the process parameter adjusted is selected from the group consisting of the proportion of free radical initiator, the proportion of an alkali earth metal stearate introduced into the polymerization mixture and both.

18. The polyethylene resin of claim 14 where a rotor SEI is measured.

19. The polyethylene resin of claim 14 where a ratio of gear pump SEI to pressure is measured.

20. The polyethylene resin of claim 14 where the rheological consistency of the polyethylene resin is improved by the method as compared to a method otherwise identical except that the rheology is not controlled as in claim 15.

21. The polyethylene resin of claim 14 where the long chain branching (LCB) of the polyethylene resin is controlled by the method as compared to a method otherwise identical except that the rheology is not controlled as in claim 15.

22. An article of manufacture comprising a polyethylene resin of claim 14.

23. An article of manufacture of claim 22 wherein the article comprises a film, a fiber, or is a blow molded or injection molded article.

24. A polyethylene resin having a controlled rheology made by the method comprising:
polymerizing ethylene monomer as a polymerization mixture;
extruding the polyethylene resin with an extruder; and
controlling the rheology of polyethylene resin by:
measuring the specific energy input (SEI) to the extruder and
adjusting a process parameter selected from the group consisting of introducing a free radical initiator selected from the group consisting of oxygen, peroxides, peroxyketals, peroxyesters, and dialkyl peroxides, and introducing an alkali metal stearate, an alkali earth metal stearate, a metal stearate and a metal oxide into the polymerization mixture, and both,
where the rheological consistency of the polyethylene resin is improved by the method as compared to a method otherwise identical except that the rheology is not controlled.

25. The polyethylene resin of claim 24 where the neutralizing species is an alkali earth metal stearate.

26. The polyethylene resin of claim 24 where the long chain branching (LCB) of the polyethylene resin is controlled by the method as compared to a method otherwise identical except that the rheology is not controlled as in claim 1.

27. An article of manufacture comprising a polyethylene resin of claim 24.
